(19) United States
(12) Patent Application Publication
(10) Pub. No.: US 2015/0278465 A1
(43) Pub. Date: Oct. 1, 2015

(54) Method and Engine for Identifying Events in a Sensor Signal Using Rate-Dependent Feature Sets

(71) Applicant: SHARP LABORATORIES OF AMERICA, INC., Camas, WA (US)

(72) Inventor: Fredrick Norman Hill, Portland, OR (US)

(73) Assignee: SHARP LABORATORIES OF AMERICA, INC., Camas, WA (US)

(21) Appl. No.: 14/228,877

(22) Filed: Mar. 28, 2014

(51) Int. Cl. G06F 19/00

(52) U.S. Cl. CPC G06F 19/3406

(57) ABSTRACT

A method and engine for identifying events in a sensor signal using rate-dependent feature sets couples trial event identifications made using different rate-dependent feature sets with rate-dependent quality assessments to overcome the mutual dependency of event attributes and the rate of events. The quality assessments compare event identifications made at different rates against quality benchmarks for event identifications at those rates, such as event stability benchmarks, to determine which feature sets are producing reliable event identifications and which are not. The invention enables electronic monitoring devices to make improved event identifications by accepting identifications made by presently reliable rate-dependent feature sets and rejecting those made by presently unreliable rate-dependent feature sets. In one application of the invention, the method and engine enable a respiration monitoring device to make improved respiration segment identifications.

### BACKGROUND OF THE INVENTION

The present invention relates to identification of events in a sensor signal and, more particularly, identifying respiration segments in a body sensor signal.

Many electronic monitoring devices identify events of interest in a sensor signal and perform analysis on those events. An example of such an electronic monitoring device is a respiration monitoring device.

Respiration is an important vital sign. Abnormal breathing, as reflected by a high or low respiration rate or inspiration to expiration ratio (I:E) or other respiration parameter, can indicate a current or imminent acute health problem, such as an asthma attack or cardiac arrest. Respiration monitoring devices monitor breathing in real-time to enable timely detection of these problems.

Different kinds of respiration monitoring devices are known. One class of devices monitors end-tidal carbon dioxide (EtCO₂) expelled by a patient. Another monitors air pressure through the patient's airways. Another monitors breath sounds emanating from the patient's body. Still others monitor chest movement associated with a patient's breathing using a belt, Doppler detector or video camera. A common feature of respiration monitoring devices is that they generate a body sensor signal that can be segmented to identify respiration segments (i.e. inspiration and expiration segments) as a function of time from which respiration parameters, such as respiration rate and I:E, can be estimated.

Various algorithms have been employed in electronic monitoring devices to identify events in sensor signals. These algorithms typically search the sensor signal for attributes of events and identify events based on these attributes. However, a common weakness of these algorithms is failure to account for the dependence of event attributes on the rate at which the events occur. Returning to the example of respiration monitoring devices, in normal breathing, the mean signal energy during inhalation and exhalation is usually much lower than in high-rate breathing. To account for this rate dependency, an optimal algorithm employed in a respiration monitoring device might use a lower energy threshold for identifying respiration segments during normal breathing than during high-rate breathing. As another example, in normal breathing, the pause following exhalation is usually longer than the pause following inhalation, whereas in high-rate breathing these pauses tend toward equal duration. To account for this rate dependency, an optimal algorithm employed in a respiration monitoring device might use pause duration as a factor in respiration segment identification during normal breathing but not during high-rate breathing. Yet segment identification algorithms executed in many respiration monitoring devices fail to account for these and other rate dependencies, degrading their performance.

Perhaps one reason that algorithms executed by electronic monitoring devices routinely fail to account for the rate dependence of event attributes is that event attributes and the rate at which events occur are mutually dependent. That is, taking the rate of events into account in selecting event attributes requires knowledge of the rate of events. Yet determining the rate of events requires application of event attributes. Returning once more to the respiration monitoring device example, lowering the energy threshold for detecting respiration segments requires knowledge that a patient has returned to breathing at a normal rate after a period of high-rate breathing. Yet determining that the patient has returned to breathing at a normal rate requires application of the energy threshold to detect respiration segments needed to determine the breathing rate.

### SUMMARY OF THE INVENTION

The present invention provides a method and engine for identifying events in a sensor signal using rate-dependent feature sets. The invention couples trial event identifications made using different rate-dependent feature sets with rate-dependent quality assessments to overcome the mutual dependency of event attributes and the rate of events. The quality assessments compare event identifications made at different rates against quality benchmarks for event identifications at those rates, such as event stability benchmarks, to determine which feature sets are producing reliable event identifications and which are not. The invention enables electronic monitoring devices to make improved event identifications by accepting identifications made by presently reliable rate-dependent feature sets and rejecting those made by presently unreliable rate-dependent feature sets. In one application of the invention, the method and engine enable a respiration monitoring device to make improved respiration segment identifications.

In one aspect of the invention, a method for identifying events in a sensor signal comprises associating different rate ranges with different event feature sets and quality metrics; receiving the signal; identifying first trial events in the signal using a first one of the event feature sets associated with a first one of the rate ranges; determining whether the first trial events pass a first quality check using a first quality metric associated with the first rate range; and selectively providing the first trial events as final events based on whether the first trial events pass the first quality check.

In some embodiments, the first trial events are provided as final events when the first quality check is passed.

In some embodiments, the first trial events are not provided as final events when the first quality check fails.

In some embodiments, the first quality check includes a comparison of a count of the first trial events with an event count threshold.

In some embodiments, the first quality check includes comparison of a rate computed using first trial events with the first rate range.

In some embodiments, the first quality check includes a comparison of rate variability computed using the first trial events with a rate variability threshold associated with the first rate range.

In some embodiments, the first quality check includes a comparison of event energy variability computed using the first trial events with an event energy variability threshold associated with the first rate range.

In some embodiments, the method further comprises identifying second trial events in the signal using a second one of the event feature sets associated with a second one of the rate ranges; determining whether the second trial events pass a second quality check using a second quality metric associated with the second rate range; and selectively providing the second trial events as final events based on whether the second trial events pass the second quality check.

In some embodiments, the event feature sets are selected as trial feature sets in order based on highest to lowest associated rate range.

In some embodiments, the event feature sets are selected as trial feature sets in order based on shortest to longest processing window.

In another aspect of the invention, an event identification engine comprises a data structure associating different rate ranges with different event feature sets and quality metrics; a first-in, first-out (FIFO) structure configured to receive feature vectors for a signal; an event finder configured to identify first trial events in the signal using a first one of the event feature sets associated with a first one of the rate ranges; and a quality monitor configured to determine whether the first trial events pass a first quality check using a first quality metric associated with the first rate range, wherein the first trial events are selectively provided as final events based on whether the first trial events pass the first quality check.

In yet another aspect of the invention, a method for identifying respiration segments in a body sensor signal comprises associating different rate ranges with different respiration segment feature sets and quality metrics; receiving the signal; identifying first trial respiration segments in the signal using a first one of the segment feature sets associated with a first one of the rate ranges; determining whether the first trial respiration segments pass a first quality check using a first quality metric associated with the first rate range; and selectively providing the first trial respiration segments as final respiration segments based on whether the first trial respiration segments pass the first quality check.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows an electronic monitoring device.

FIG. 2 shows an event identification engine.

FIG. 3 shows a method for identifying events in a sensor signal using rate-dependent event feature sets.

FIG. 4 shows a method for performing a rate-dependent quality check.

### DETAILED DESCRIPTION OF A PREFERRED EMBODIMENT

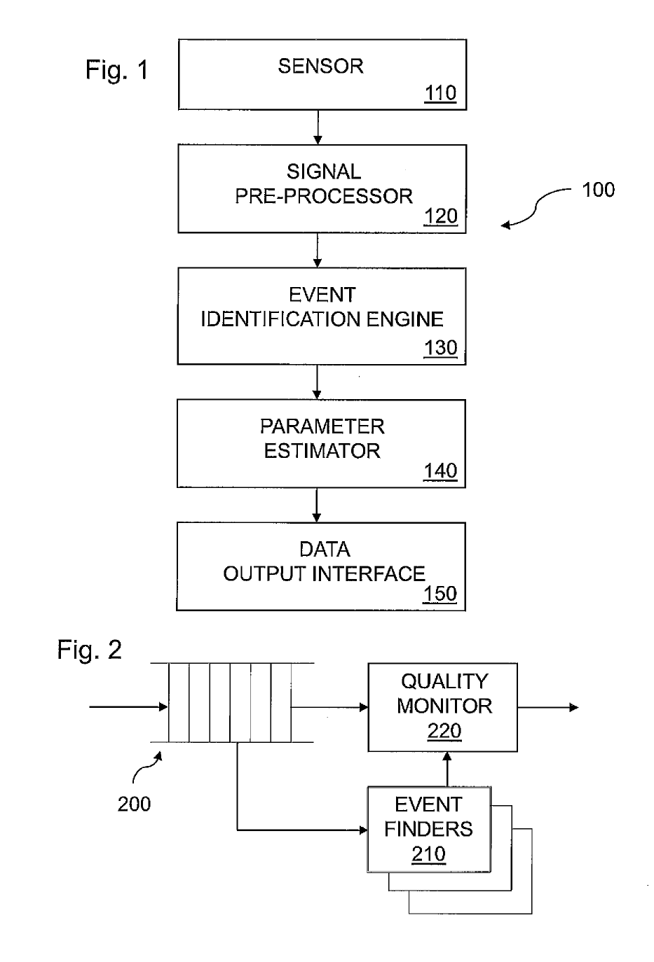

FIG. 1 shows an electronic monitoring device 100 in some embodiments of the invention. Device 100 has a sensor 110 that generates a sensor signal having samples that record events being monitored. Sensor 110 may take various forms. For example, sensor 110 may be an acoustic sensor having a microphone capturing sounds associated with events. Alternatively, sensor 110 may detect changes in condition, such as changes in position (movement), air pressure or density, associated with events. Sensor 110 continually transmits a sensor signal waveform to signal preprocessor 120.

Signal preprocessor 120 preprocesses the sensor signal waveform received from sensor 110 to prepare the signal for processing by event identification engine 130. Preprocessor 120 extracts signal attributes from the sensor signal waveform to yield feature vectors. Each feature vector characterizes a segment of the signal over a predetermined time interval in terms of attributes useful for event identification. Preprocessor 120 may perform other preparatory operations on the signal waveform, such as noise spike removal. Preprocessor 120 continually transmits feature vectors to event identification engine 130, which identifies a series of events of interest in the input signal from the feature vector sequence. Parameter estimator 140 uses the series of events to compute parameters of interest and transmits to data output interface 150 output data generated based at least in part on these parameters. Data output interface 150 may, for example, display the output data locally, relay them to a remote facility, or write the events to a data log.

FIG. 2 shows event identification engine 130 in more detail. Engine 130 continually receives feature vectors on a FIFO structure 200 (“FIFO 200”) from preprocessor 120 and invokes different rate-dependent event finders 210, each using a distinct event feature set, to identify trial events from the feature vectors on FIFO 200. The resulting trial events are evaluated by quality monitor 220, which forwards valid events to parameter estimator 140 and advances FIFO 200. Engine 130 may perform its operations through execution of software instructions by a microprocessor, in custom circuitry, or a combination.

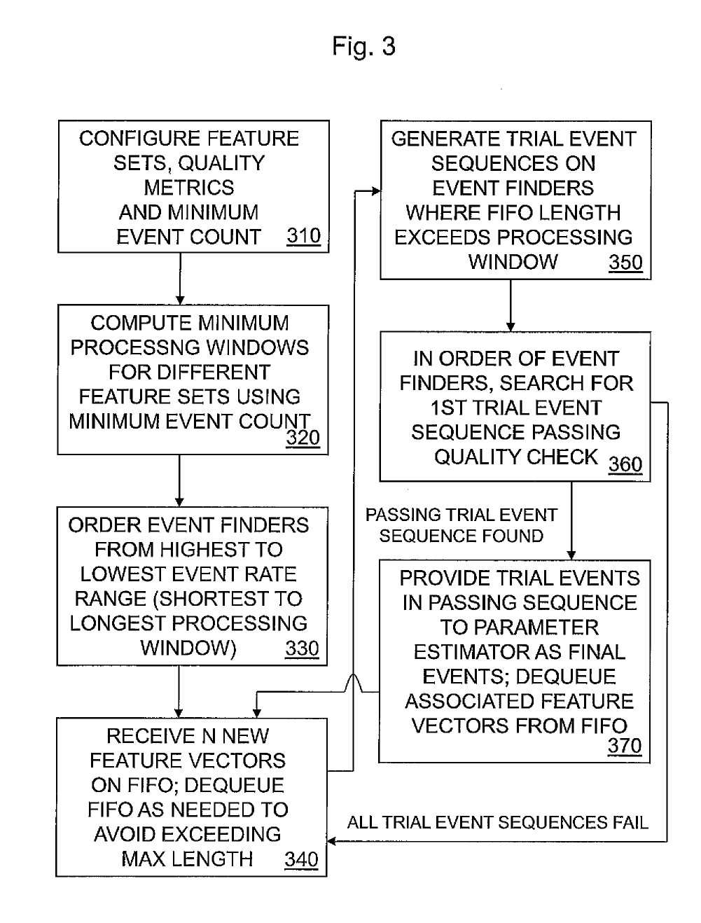

FIG. 3 shows an event identification method performed on engine 130 in some embodiments of the invention. The method includes a configuration phase and an operating phase.

In the configuration phase, event feature sets, quality metrics and a minimum event count are configured on engine 130 (310). Event feature sets are sets of attributes used to identify events in the input signal over time from the feature vector sequence on FIFO 200. Different event feature sets are configured for different event rate ranges to account for the dependence of some event attributes on the rate at which events occur. For example, where the events to be identified are respiration segments (i.e. inspiration and expiration), the feature set associated with normal-rate breathing might use features with an energy threshold set to a lower value than the feature set for high-rate breathing. As another example, the feature set for normal-rate breathing might include pause duration between events as an event identification feature whereas the feature set for high-rate breathing may exclude that feature.

Quality metrics are quality benchmarks used to determine whether event identifications made by event feature sets are reliable. Quality metrics include, without limitation, event rate variability thresholds and event energy variability thresholds. As with event feature sets, different quality metrics are configured for different event rate ranges to account for the dependence of some quality metrics on the rate at which events occur. For example, in many domains, stability of event statistics is known to improve at higher event rates. That is, as the event rate increases, event rate variability and event energy variability decrease. Thus, quality metrics for high event rate ranges may require lower event rate variability and event energy variability than those for lower event rate ranges.

Event feature sets and quality metrics may be factory or user-configured. Event finders 210 have individual states which include event feature sets and quality metrics for their associated rate ranges. These states may be maintained in individual data structures on event finders 210 or in a group data structure on engine 130 having different entries for different ones of event finders 210.

The minimum event count is set based on parameters to be extracted from events identified in the feature vector sequence and a desired level of statistical confidence for such parameters. For example, where the events are respiration segments and the parameter to be extracted is respiration rate, a minimum event count of at least two is required (i.e. one inspiration segment and one expiration segment). However, the minimum event count may be judiciously set higher to span multiple respiration cycles and thereby improve statistical confidence in the extracted respiration rate. The configured minimum event count applies across all rate ranges and may be factory or user-configured on engine 130.

Next, event finders 210 compute minimum processing windows for their respective event feature sets using the minimum event count (320). A minimum processing window for an event feature set is computed as the product of the minimum event count and the maximum mean event interval (center-to-center) for the event rate range associated with the event feature set. For example, where the minimum event count is four and the event rate range associated with the event feature set is 10 to 30 events per minute, the maximum mean event interval for the event rate range is 60 seconds divided by 10 events, or six seconds, and the minimum processing window for the event feature set is 24 seconds. A minimum processing window is individually computed for each event feature set. Note that where the events being identified are respiration segments and the parameter being extracted is respiration rate, the event rate is not synonymous with respiration rate since a respiration cycle includes two respiration segments (i.e. an inspiration segment and an expiration segment). The computed minimum processing windows for different event feature sets may be saved to the different event finder states.

As the final configuration step, event finders 210 are sequenced based on their associated event rate ranges (i.e. from highest to lowest event rate range; shortest to longest processing window) (330). Giving preference to feature sets having shorter processing windows has advantages, such as reduced latency in event identification and improved noise immunity from better event stability at higher event rates. The sequence is saved in a data structure on or accessible to quality monitor 220 for later use in Step 350.

In the operating phase, signal preprocessor 120 adds N feature vectors to the tail of FIFO 200 (340), where N is a predetermined positive integer. FIFO 200 is dequeued as needed to avoid exceeding the FIFO maximum length.

Next, event finders 210 individually execute to identify trial event sequences, subject to the length of their associated minimum processing windows and the current length of FIFO 200 (350). An event finder executes if and only if the current length of FIFO 200 is greater than or equal to the length of the minimum processing window associated with the event finder. On execution, an event finder classifies each feature vector on FIFO 200 as either a logical one (conforming) or logical zero (non-conforming) based on conformance of the feature vector with the event feature set associated with the event finder, producing a binary sequence whose length corresponds to the number of feature vectors on FIFO 200. The classifications may be made, for example, using a structure (e.g. support vector) resulting from a training set or comparisons with an expert reference. The event finder designates contiguous sequences of logical ones within the binary sequence that are longer than or equal to a predetermined minimum length as trial events and determines the start and end times of trial events from the beginnings and ends of these contiguous sequences. The event finder then provides to quality monitor 220 a trial event sequence identifying these start and end times.

Next, quality monitor 220 evaluates the trial event sequences provided by event finders 210 (360). The evaluation is ordered in accordance with the order of event finders 210 established in Step 330 (i.e. highest to lowest event rate range; shortest to longest processing window). If a trial event sequence provided by the event finder currently being evaluated passes the quality check for the associated event finder, the trial events in that sequence are designated as final events and are provided to parameter estimator 140, with FIFO 200 being dequeued through the end time of the last of these events, minus any processing margin required by event finders 210 (370), and the flow returns to Step 340. If no trial event sequence passes its quality check, the flow returns to Step 340 without providing final events to parameter estimator 140 or associated dequeueing.

The quality check is performed to assess whether event identifications made by a given event finder are reliable. The quality check uses rate-dependent quality metrics, such as an event rate variability threshold and an event energy variability threshold that are associated with the event rate range of the event finder.

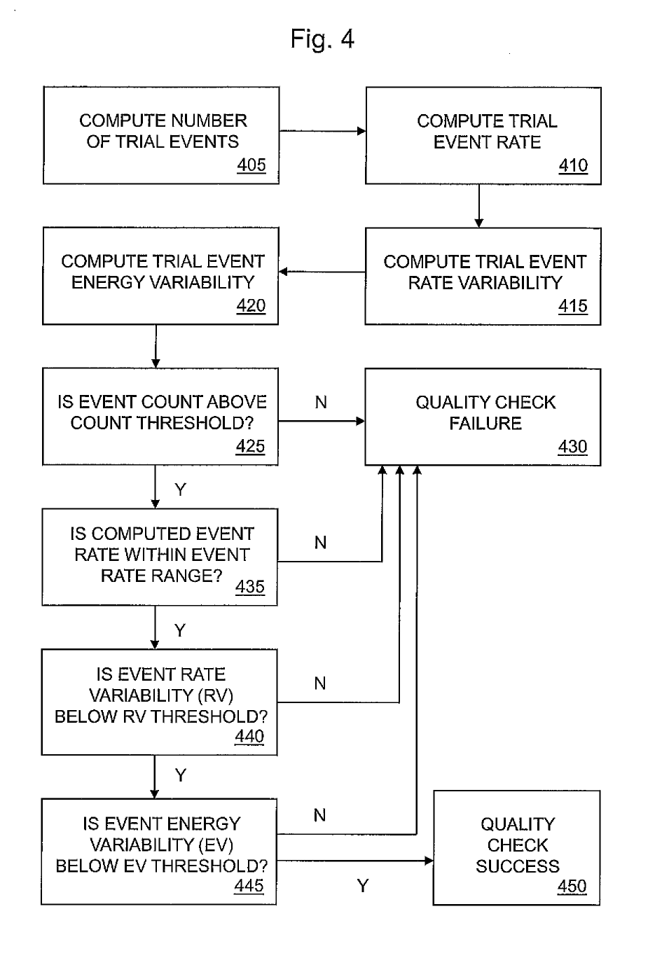

Turning to FIG. 4, a method for performing a rate-dependent quality check is shown. Quality monitor 220 calculates the number of trial events (405) and the event rate (410). Quality monitor 220 further computes the variability in the rate of the trial events (415) and the variability in the energy of the trial events (420). The event rate variability is computed as the ratio of the standard deviation of the mean event interval (center-to-center) and the mean event interval. The event energy variability is computed as the ratio of the standard deviation of the mean event energy and the mean event energy.

Next, quality monitor 220 conducts a series of queries on the trial events, some of which use the rate-dependent quality metrics. First, quality monitor 220 determines whether the computed number of trial events is above an event count threshold (425). If so, quality monitor 220 determines whether the computed event rate is within the event rate range of the event finder that generated the trial event sequence (435). If so, quality monitor 220 determines whether the computed event rate variability is below the event rate variability threshold for the event rate range (440). If so, quality monitor 220 finally determines whether the computed event energy variability is below the event energy variability threshold for the event rate range (445). If all of the queries are answered in the affirmative, the trial events pass the quality check and are provided as final events (430). On the other hand, if any of the queries is answered in the negative, the trial events fail the quality check and are not provided as final events (450).

In some embodiments, device 100 is a respiration monitoring device. In these embodiments, sensor 110 is a body sensor that generates a body sensor signal having samples that capture breathing (i.e. inspiration and expiration) of a human patient being monitored. Such a body sensor may be an acoustic sensor that has a microphone capturing breath sounds, or may capture EtCO₂ expelled by a patient, or may capture air pressure through a patient's airways, or may capture chest movement associated with a patient's breathing using a belt, Doppler detector or video camera. In these embodiments, the events identified by event identification engine 130 in the sensor signal are respiration segments that, when finalized, are used by parameter estimator 140 to compute respiration parameters, such as respiration rate and I:E ratio, that are outputted directly or used to derive other respiration-related data outputted on or via data output interface 150.

It will be appreciated by those of ordinary skill in the art that the invention can be embodied in other specific forms without departing from the spirit or essential character hereof. The present description is considered in all respects to be illustrative and not restrictive. The scope of the invention is indicated by the appended claims, and all changes that come within the meaning and range of equivalents thereof are intended to be embraced therein.

What is claimed is:

1. A method for identifying events in a sensor signal, comprising:
associating different rate ranges with different event feature sets and quality metrics;
receiving the signal;
identifying first trial events in the signal using a first one of the event feature sets associated with a first one of the rate ranges;
determining whether the first trial events pass a first quality check using a first quality metric associated with the first rate range; and
selectively providing the first trial events as final events based on whether the first trial events pass the first quality check.

2. The method of claim 1, wherein the first trial events are provided as final events when the first quality check is passed.

3. The method of claim 1, wherein the first trial events are not provided as final events when the first quality check fails.

4. The method of claim 1, wherein the first quality check includes a comparison of a count of the first trial events with an event count threshold.

5. The method of claim 1, wherein the first quality check includes comparison of a rate computed using first trial events with the first rate range.

6. The method of claim 1, wherein the first quality check includes a comparison of rate variability computed using the first trial events with a rate variability threshold associated with the first rate range.

7. The method of claim 1, wherein the first quality check includes a comparison of event energy variability computed using the first trial events with an event energy variability threshold associated with the first rate range.

8. The method of claim 1, further comprising:
identifying second trial events in the signal using a second one of the event feature sets associated with a second one of the rate ranges;
determining whether the second trial events pass a second quality check using a second quality metric associated with the second rate range; and
selectively providing the second trial events as final events based on whether the second trial events pass the second quality check.

9. The method of claim 1, wherein the event feature sets are selected as trial feature sets in order based on highest to lowest associated rate range.

10. The method of claim 1, wherein the event feature sets are selected as trial feature sets in order based on shortest to longest processing window.

11. An event identification engine, comprising:
a data structure associating different rate ranges with different event feature sets and quality metrics;
a first-in, first-out (FIFO) structure configured to receive feature vectors for a signal;
an event finder configured to identify first trial events in the signal using a first one of the event feature sets associated with a first one of the rate ranges; and
a quality monitor configured to determine whether the first trial events pass a first quality check using a first quality metric associated with the first rate range, wherein the first trial events are selectively provided as final events based on whether the first trial events pass the first quality check.

12. The engine of claim 11, wherein the first trial events are provided as final events when the first quality check is passed.

13. The engine of claim 11, wherein the first trial events are not provided as final events when the first quality check fails.

14. The engine of claim 11, wherein the first quality check includes a comparison of a count of the first trial events with an event count threshold.

15. The engine of claim 11, wherein the first quality check includes comparison of a rate computed using first trial events with the first rate range.

16. The engine of claim 11, wherein the first quality check includes a comparison of rate variability computed using the first trial events with a rate variability threshold associated with the first rate range.

17. The engine of claim 11, wherein the first quality check includes a comparison of event energy variability computed using the first trial events with an event energy variability threshold associated with the first rate range.

18. The engine of claim 11, wherein the event finder is further configured to identify second trial events in the signal using a second one of the event feature sets associated with a second one of the rate ranges and the quality monitor is further configured to determine whether the second trial events pass a second quality check using a second quality metric associated with the second rate range, wherein the second trial events are selectively provided as final events based on whether the second trial events pass the second quality check.

19. The engine of claim 11, wherein the event feature sets are selected as trial feature sets in order based on highest to lowest associated rate range.

20. A method for identifying respiration segments in a body sensor signal, comprising:
associating different rate ranges with different respiration segment feature sets and quality metrics;
receiving the signal;
identifying first trial respiration segments in the signal using a first one of the segment feature sets associated with a first one of the rate ranges;
determining whether the first trial respiration segments pass a first quality check using a first quality metric associated with the first rate range; and
selectively providing the first trial respiration segments as final respiration segments based on whether the first trial respiration segments pass the first quality check.
